(19) United States
(12) Patent Application Publication
(10) Pub. No.: US 2026/0025798 A1
(43) Pub. Date: Jan. 22, 2026

(54) DYNAMIC SCHEDULER IN TELECOMMUNICATIONS NETWORKS

(71) Applicant: DISH Wireless L.L.C., Englewood, CO (US)

(72) Inventors: Mehdi Alasti, Arlington, VA (US); Dilip Tandekar, Herndon, VA (US); Sang Boh Yun, Ashburn, VA (US); Siddhartha Chenumolu, Ashburn, VA (US)

(21) Appl. No.: 18/776,773

(22) Filed: Jul. 18, 2024

(51) Int. Cl. H04W 72/0446; H04W 72/50

(52) U.S. Cl. CPC H04W 72/0446; H04W 72/50

(57) ABSTRACT

Systems and methods of scheduling traffic perform or comprise receiving a data frame, the data frame including a series of timeslots ordered according to an unordered schedule, wherein the series of timeslots includes at least two noncontiguous groups of data timeslots; calculating a revised schedule for the data frame, wherein the revised schedule differs from the unordered schedule in at least one of a time domain characteristic or a frequency domain characteristic; rearranging the timeslots of the data frame according to the revised schedule in at least one of the time domain or the frequency domain, such that the revised schedule includes fewer transmission periods than the unordered schedule; and causing a transmitter of the telecommunications network to transmit the data frame according to the revised schedule.

### BACKGROUND

This disclosure relates to wireless data networks, such as 5G and 6G wireless networks. Wireless networks that transport digital data and telephone calls are becoming increasingly sophisticated. Currently, fifth generation (5G) broadband cellular networks are being deployed around the world. These 5G networks use emerging technologies to support data, voice communications, Internet of Things (IoT), and more with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a virtualized telecommunications network to dynamically schedule communications, for example to achieve improved power efficiency.

According to one aspect of the present disclosure, a method of scheduling traffic in a telecommunications network is provided. The method comprises receiving a data frame, the data frame including a series of timeslots ordered according to an unordered schedule, wherein the series of timeslots includes at least two noncontiguous groups of data timeslots; calculating a revised schedule for the data frame, wherein the revised schedule differs from the unordered schedule in at least one of a time domain characteristic or a frequency domain characteristic; rearranging the symbols of the data frame according to the revised schedule in at least one of the time domain or the frequency domain, such that the revised schedule includes fewer transmission periods than the unordered schedule; and causing a transmitter of the telecommunications network to transmit the data frame according to the revised schedule.

According to another aspect of the present disclosure, a network node in a telecommunications network is provided. The network node comprises at least one processor in communication with a wireless access point; and a memory storing instructions that, when executed by the at least one processor, cause the network node to: receive a data frame, the data frame including a series of timeslots ordered according to an unordered schedule, wherein the series of timeslots includes at least two noncontiguous groups of data timeslots, calculate a revised schedule for the data frame, wherein the revised schedule differs from the unordered schedule in at least one of a time domain characteristic or a frequency domain characteristic, rearrange the symbols of the data frame according to the revised schedule in at least one of the time domain or the frequency domain, such that the revised schedule includes fewer transmission periods than the unordered schedule, and cause a transmitter of the wireless access point to transmit the data frame according to the revised schedule.

According to another aspect of the present disclosure, a non-transitory computer-readable medium is provided. The non-transitory computer-readable medium stores instructions that, when executed by at least one processor of a computer in a telecommunications network, cause the compute to perform operations comprising: receiving a data frame, the data frame including a series of timeslots ordered according to an unordered schedule, wherein the series of timeslots includes at least two noncontiguous groups of data timeslots; calculating a revised schedule for the data frame, wherein the revised schedule differs from the unordered schedule in at least one of a time domain characteristic or a frequency domain characteristic; rearranging the symbols of the data frame according to the revised schedule in at least one of the time domain or the frequency domain, such that the revised schedule includes fewer transmission periods than the unordered schedule; and causing a transmitter of the telecommunications network to transmit the data frame according to the revised schedule.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3A illustrates an example of a frame structure in the time domain, in accordance with a comparative example.

FIG. 3B illustrates an example of a frame structure in the time domain, in accordance with various aspects of the present disclosure.

FIG. 4A illustrates an example of a frame structure in the frequency domain, in accordance with a comparative example.

FIG. 4B illustrates an example of a frame structure in the frequency domain, in accordance with various aspects of the present disclosure.

FIG. 4C illustrates an example of a frame structure in the frequency domain, in accordance with various aspects of the present disclosure.

FIG. 5 illustrates an example of a dynamic scheduling method in accordance with various aspects of the present disclosure.

FIG. 6 illustrates an example of a dynamic scheduling system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE), fifth-generation (5G) network standards such as New Radio (NR), and/or sixth-generation (6G) network standards; In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

Network energy consumption is a significant factor in the deployment and operation of telecommunications networks, including the O-RAN networks (and/or networks in accordance with other standards) described above. It has been estimated that the radio access network (RAN) component of network infrastructure accounts for approximately 73% of the energy of a wireless network. Power amplifiers (PAS) alone account for almost 17% of wireless network energy consumption. Therefore, there exists a need for systems and methods of reducing power consumption by RAN components in telecommunication networks, for example by reducing power consumption of PAs.

The present disclosure describes dynamic systems and methods of scheduling communications in a network, such as a 5G standalone telecommunications network. One method to reduce the energy consumption of a PA is to turn it to an ON state (e.g., a state in which it receives power) during transmissions and to turn it to an OFF state (e.g., a state in which it does not receive power) when there are no transmissions occurring. In a 5G network that implements orthogonal frequency-division multiplexing (OFDM), in the time domain one frame of communication has a duration of 10 milliseconds (ms) and is divided into ten subframes each having a duration of 1 msec. The subframes are divided into slots, and each slot is divided into a number of symbols. The number of slots per subframe depends on the “numerology” of the frame structure, which refers to a set of parameters such as the subcarrier spacing (SCS), the symbol duration, and the cyclic prefix length. In general, the number of slots per subframe Nₛₗ=2^{μ}, where the numerology μ is an integer between 0 and 6. For all numerologies, the number of symbols per slot is 14 for symbols with a normal cyclic prefix (CP) and 12 for symbols with an extended CP (for μ=2). Thus, the duration of each symbol

$${t}_{sy} = \frac{1}{14 \cdot {2}^{μ}}$$

in ms, including the CP.

In the frequency domain, a communication includes a number of physical resource blocks (PRBs), each of which includes 12 subcarriers. The bandwidth of each subcarrier depends on the numerology according to the relationship Δf=2^{μ}·15 in kilohertz (kHz). Thus, for an SCS of 15 kHz, one PRB occupies 180 kHz in the frequency domain. A wireless network's channel bandwidth contains a specific number of PRBs M; for example, if M=25 then the bandwidth is 5 megahertz (MHz).

In an OFDM implementation, an individual PA may be turned on or off at a granularity of individual OFDM symbols. There is a transition time between the ON state and the OFF state; although the transition time is short, the transitions consume energy. Thus, the present disclosure provides systems and methods to reduce the energy consumption of power amplifiers. For example, the present disclosure provides systems and methods to dynamically schedule transmissions to reduce the number of PA ON/OFF transitions during a given 5G NR frame, such that a gNB has a reduced number (e.g., one) of active periods (when the PA is in an ON state) followed by a reduced number (e.g., one) of inactive periods (when the PA is in an OFF state) per frame.

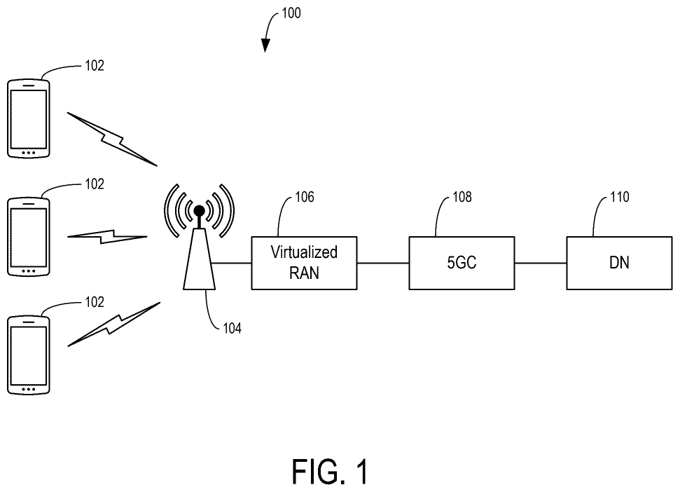

FIG. 1 illustrates an example of a telecommunications network 100 in accordance with various aspects of the present disclosure. In the telecommunications network 100 of FIG. 1, a plurality of user equipment (UEs) 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (Aps), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

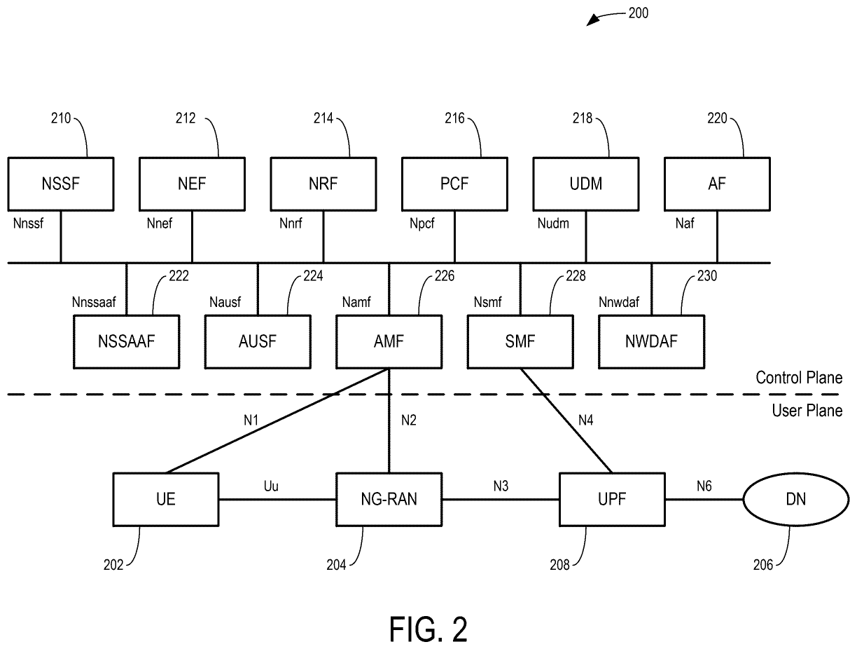

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes a control plane (CP). The CP comprises a plurality of CP network functions (NFs). The user plane (UP) comprises a UE 202 (e.g., one of the UEs 102 of FIG. 1) connected to an NG-RAN 204, and UP NFs (e.g., UPFs). Using the SBA 200, the UE 202 accesses a data network 206 (e.g., the data network 110 of FIG. 1). For case of illustration, FIG. 1 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the user plane of service and packet gateway functions in a 4G network, but it is cloud-native and can be deployed anywhere to meet service requirements. It can also manage, prioritize, and duplicate data packets as they traverse the network, thus offering redundancy and quality-of-service (QOS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the control plane tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the architecture 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the architecture 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be connected to and control a power amplifier and transmission elements (e.g., antennae) configured to cooperate to transmit signals to connected UEs 202 according to a transmission schedule. The transmission schedule may be determined by a scheduler residing in a network component, which in some examples may be located at a higher level within the network as compared to the DU. For example, the scheduler may reside in the DU and/or in another component of the virtualized RAN components 106. In particular examples, the scheduler may be provided at the site level, at the network level, at a particular geographic level, and so on. The scheduler may determine the transmission schedule and provide it to those RUs that are assigned to the scheduler, and the RUs may in turn instruct the physical radio resources assigned thereto to turn on/off the transmission components (e.g., the PAs) in accordance with the transmission schedule.

As noted above, each PA ON to PA OFF transition and each PA OFF to PA ON transition consumes some energy. The energy consumption of a given PA has two components: a static energy due to bias of the PA to operate in the linear region and a dynamic energy component that depends on the transmission and is due to the periods in which the power level of the PA is powering on or off. By implementing the systems and methods described herein, the energy consumption of the PAs in a network may be substantially reduced. In one test of the systems and methods set forth herein, the energy consumption of the PAs was reduced by 55% for midband RUs and 7% for lowband RUs. In another test of the systems and methods set forth here, the energy consumption of the PAs was reduced by 61% for midband RUs and 51% for lowband RUs. The reduction in energy consumption may be achieved by, at least in part, a reduction in the energy consumed for PA ON/OFF transitions.

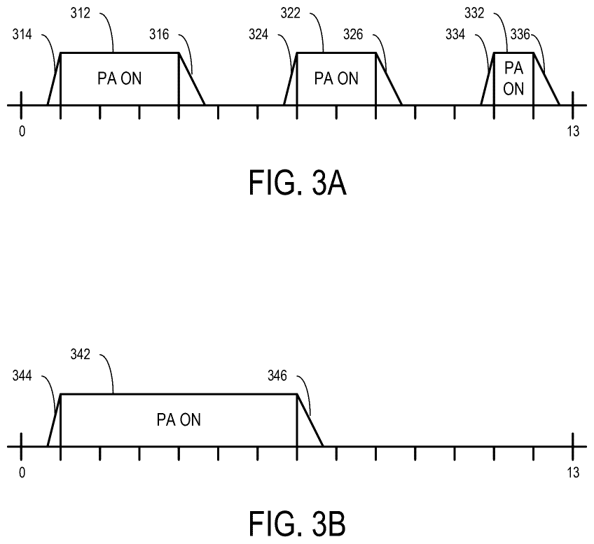

In the time domain, this is illustrated in FIG. 3A, which illustrates a power state as a function of time for a PA of an RU operating under the control of a comparative scheduler; and in FIG. 3B, which illustrates a power state as a function of time for a PA operating under the control of a scheduler in accordance with the present disclosure. In FIGS. 3A and 3B, the vertical axis corresponds to a power level of the PA, and the horizontal axis corresponds to time. Each full tick on the horizontal axis corresponds to a frame, and each half tick on the horizontal axis corresponds to a symbol. Thus, FIGS. 3A and 3B illustrate the transmission characteristics of a single transmission frame having 14 symbols.

In the comparative example of FIG. 3A, the RU transmits the frame data in three separate transmission bursts: a first burst 312 for time-slots (or, in implementations, symbols or groups of symbols) 1-3, a second burst 322 for time-slots (or symbols or groups thereof) 7 and 8, and a third burst 332 for time-slot (or symbol or group) 12. In order to ensure that the PA is fully powered for each transmission burst, the PA must begin powering on prior to the beginning of each burst. Thus, the first burst 312 is preceded by a first on-transition 314, the second burst 322 is preceded by a second on-transition 324, and the third burst 332 is preceded by a third on-transition 334. Moreover, even after the PA is powered off, it takes some time for the power to return to zero. Thus, the first burst 312 is followed by a first off-transition 316, the second burst 322 is followed by a second off-transition 326, and the third burst 332 is followed by a third off-transition 336. Each on-transition and each off-transition contributes to the power consumption of the PA, even though no data is transmitted during the on- and off-transitions. The total power consumption of the PA for the frame is equal to the PA ON level for six time-slots (or symbols or groups) plus the power consumption during the three on-transitions and the three off-transitions.

Thus, the present disclosure provides for systems and methods of scheduling transmissions that reduce the power consumption during periods in which no data is transmitted. In the example shown in FIG. 3B, the RU transmits the frame data in only a single transmission burst 342 for symbols 1-6. Thus, there is only a single on-transition 342 and a single off-transition 346. Even though the example illustrated in FIG. 3B transmits the same amount of data (six time-slots, symbols, or groups) as the example illustrated in FIG. 3A, the example illustrated in FIG. 3B includes two fewer on-transitions and two fewer off-transitions, leading to a reduced power consumption in the frame. While FIG. 3B illustrates an example where the transmission is scheduled such that it occurs within only a single burst, in other examples the transmission may be scheduled such that the transmission occurs within any reduced number of bursts as compared to the comparative example.

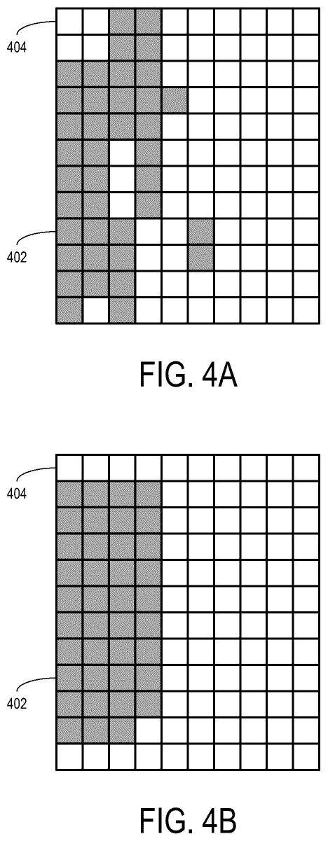

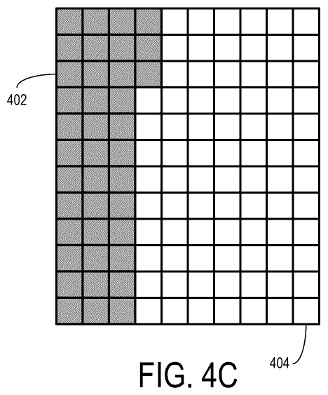

In both the time and frequency domains, the power consumption is illustrated in FIG. 4A, which illustrates a power state across many frequency blocks as a function of time for a PA of an RU operating under the control of a comparative scheduler; and in FIG. 4B, which illustrates a power state across many frequency blocks as a function of time for a PA operating under the control of a scheduler in accordance with the present disclosure. In FIGS. 4A and 4B, the vertical axis corresponds to frequency, the horizontal axis corresponds to time, and each square represents one scheduling resource (e.g., one PRB) for one time-slot. Shaded blocks 402 represent PRBs scheduled for transmission. Thus, FIGS. 4A and 4B illustrate the transmission characteristics of a transmission frame having 10 time-slots using 12 PRBs. The example transmission includes 39 transmission blocks.

In the comparative example of FIG. 4A, the comparative scheduler simply transmits the data without shaping in the time or frequency domains. According to this scheme, one or more time-slot may be incomplete (i.e., not completely filled in the frequency domain). In the illustrated example, 10 PRBs are used to transmit during the first time-slot, 9 PRBs are used to transmit during the second and third time-slots (although each time-slot uses a different combination of PRBs), 8 PRBs are used to transmit during the fourth time-slot, 1 PRB is used to transmit during the fifth time-slot, and 2 PRBs are used to transmit during the sixth time-slot. Thus, the power consumption of the PAs for the frame is equal to the PA dynamic energy consumption for 39 PRBs plus the static power consumption during six time-slots.

However, in the example of FIG. 4B, the dynamic scheduler in accordance with the present disclosure shapes the data before transmission such that the number of PRBs used for transmission is equal or nearly equal across all symbols. This may be accomplished by, in one example, performing a calculation to obtain the preferred number of time-slots and duration for which the PA must be at the ON level to transmit all of the data for the frame with reduced (and in some implementations, minimum) power consumption. In the illustrated example of FIG. 4B, 10 PRBs are used to transmit during the first three time-slots and 9 PRBs are used to transmit during the fourth time-slot. Thus, the power consumption of the PAs for the frame is equal to the PA dynamic energy consumption for 39 PRBs plus the static power consumption during four time slots. Because the PA is on for fewer time-slots, the schedule shown in FIG. 4B provides power savings compared to the schedule shown in FIG. 4A.

Moreover, even if the number of time-slots for which the PA is on is the same in the comparative example as in the systems and methods of the present disclosure, the dynamic scheduler may provide additional advantages. For example, FIG. 4C illustrates another situation in which the comparative scheduler transmits the data without shaping in the time or frequency domains. According to the illustrated example, all 12 PRBs are used to transmit during the first three time-slots, and 3 PRBs are used to transmit during the fourth time-slot. The comparative schedule includes the PRBs at the edges of the spectrum (i.e., the top and bottom rows shown in FIG. 4C), which may result in out of band emission that affects network operators operating in the neighboring frequency ranges of the spectrum. By reshaping the schedule using a dynamic scheduler (e.g., such that the transmission schedule becomes that shown in FIG. 4B), the PRBs at the two edges of the spectrum are empty, thereby reducing the out of band emission and its effect on the neighboring operators. This is true even if, as can be seen by comparing FIGS. 4B and 4C in the time domain, the PA ON time is the same.

Accordingly, the present disclosure provides for a dynamic scheduler that reduces the energy consumption of the PAs and thus of the network as a whole. Assuming that the PA energy consumption is linear and the static energy during a time-slot that PA is active is represented by S, then the total energy consumption during a time-slot to transmit n PRBs is P(n)=S+nE. To reduce the PA energy consumption, the dynamic scheduler may combine the transmissions into a reduced number of transmission time-slots. For example, to minimize the PA energy consumption, the dynamic scheduler may combine all transmissions into the fewest number of time-slots.

If the power consumption during a time-slot follows a different pattern (i.e., a non-linear function) of n, the dynamic scheduler may calculate a preferred number of scheduled PRBs during a slot. Mathematically, it can be shown that for the preferred scheduling, the number of scheduled PRBs in slots during PA ON are equal or nearly equal (e.g., as shown in FIG. 4B). If K represents the number of slots during which the PA is on, N is the total number of PRBs to transmit during the PA ON period, and P(n) is the PA power consumption during a slot for n PRBs, then one can represent the number of to be scheduled PRBs in each slot as

$$n = \frac{N}{K}$$

and the total power consumption in a frame as

$$Q = K \cdot P ( n ) = K \cdot P ( \frac{N}{K} ) .$$

Accordingly, it is possible to determine the value of K to minimize Q by setting its derivative to zero, as set forth in the following expression:

$${Q}^{′} = P ( \frac{N}{K} ) + K ( - \frac{N}{{K}^{2}} ) {P}^{′} ( \frac{N}{K} ) = P ( \frac{N}{K} ) - ( \frac{N}{K} ) {P}^{′} ( \frac{N}{K} ) = 0$$

This may be solved to obtain the preferred value of K and thus to transmit N/K PRBs in each slot. In one example non-linear power consumption model, where P(n)=An²+S and thus P′(n)=2An, Q′ is represented by the following expression:

$$P ( \frac{N}{K} ) - ( \frac{N}{K} ) {P}^{′} ( \frac{N}{K} ) = A {( \frac{N}{K} )}^{2} + S - 2 A {( \frac{N}{K} )}^{2}$$

and thus, setting Q′ to zero,

$$A {( \frac{N}{K} )}^{2} = S$$

and the dynamic scheduler may schedule

$$\frac{N}{K} = \sqrt{\frac{S}{A}} PRBs$$

over

$$K = N \sqrt{\frac{S}{A}} time - slots .$$

The values of A and S may be a characteristic of the particular manufacturer, model, and/or make of the PA.

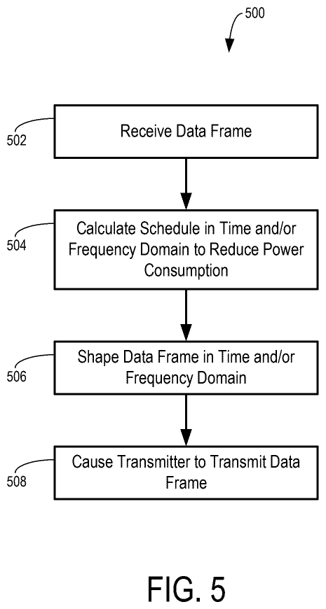

FIG. 5 illustrates an example method 500 for dynamic scheduling. The method 500 may be performed by a device in a telecommunications network that is located upstream of and/or operates to control one or more RUs. In one example, the method 500 may be performed in a network node forming part of the virtualized RAN components 106 at the regional, national, or other geographic level. For purposes of explanation, the method 500 will be referred to as being performed by a “dynamic scheduler” or “intelligent scheduler.”

The method 500 begins with an operation 502 of receiving one or more data frames, the data frame(s) being intended for transmission by an RU that operates under the control of the dynamic scheduler. Thus, the method 500 may be performed for each frame, or may be performed for a group of frames. An individual data frame may include payload data, control data, metadata, and the like. In one example, upon receipt, the data frame may be associated with an unordered schedule (e.g., a schedule that has not had any reordering algorithm applied thereto), such as that resembling the power waveform illustrated in FIG. 3A (e.g., data to be transmitted in certain noncontiguous symbols). In this regard, a time-slot (which, as noted above, depends on the time granularity in scheduling) of the frame/data frame that includes data to be transmitted is referred to as a “data timeslot” and a slot of the data frame that does not include data to be transmitted is referred to as an “empty timeslot.” As shown in FIG. 3A, the unordered data frame includes data timeslots and empty timeslots, with at least two noncontiguous groups of data timeslots (e.g., groups separated by at least one empty timeslot).

At operation 504, the dynamic scheduler calculates a revised schedule for the data frame that reduces power consumption. The revised schedule may be different from the initial schedule (as received in operation 502) in its time domain characteristics (see FIG. 3B) and/or in its frequency domain characteristics (see FIG. 4B). This may be performed by performing the calculations described above (e.g., determining a relationship between schedule and power consumption, taking the derivative of the relationship, and calculating the schedule using the derivative).

Thus, operation 506 may include temporally rearranging the data transmissions within the frame such that the number of transmission periods is reduced. In the example illustrated in FIGS. 3A-B, and as described above, this may include rescheduling the data transmissions into a single contiguous transmission period. Operation 506 may additionally or alternatively include modifying the allocation of the data transmissions to frequency resources, such as subcarriers/PRBs. In the example illustrated in FIGS. 4A-4C, this may include rescheduling the data transmissions into a constant number of frequency resources (or as near to constant as possible). Operations 504 and 506 may operate to reduce (e.g., minimize) the overall number of power ON to power OFF transitions and/or the overall number of power OFF to power ON transitions, thus reducing (e.g., minimizing) the power consumption due to rise or fall times of power applied to the PAs of the RU.

At operation 508, the dynamic scheduler may cause the transmitter (e.g., the RU) to transmit the reshaped data frame (i.e., to transmit the data frame according to the revised schedule). For example, the dynamic scheduler may pass the reshaped data frame to the transmitter, such that the transmitter transmits the reshaped data frame (as opposed to the data frame with an unordered schedule as received in operation 502) according to its usual operation.

The operations of method 500 need not be performed one after another in the sequence illustrated in FIG. 5. For example, in some implementations certain operations may be performed in parallel and/or in an interlaced manner. In one particular example, the dynamic scheduler may perform operation 504 on one data frame or set of data frames while simultaneously receiving (e.g., performing operation 502 on) a subsequent data frame or set of data frames, and so on. Thus, the operations of the method 500 may be performed so as to reduce any processing delays in the network. Moreover, in some implementations certain operations may be performed only once while other operations are performed multiple times. In one particular example, operation 504 may be performed a single time to determine a set of schedule conditions that reduce power consumption (e.g., based on the model of the RU and/or PA), and the results of 504 may be used for multiple iterations of operation 506 using multiple successive data frames (e.g., multiple iterations of operation 502).

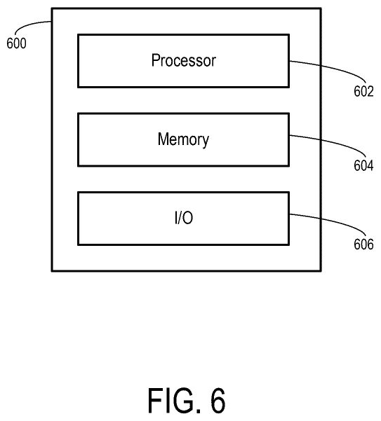

The method 500 may be implemented by a device operating in a telecommunications network. For example, in a telecommunications network including a wireless access point (e.g., wireless access point 104 of FIG. 1) configured to communicate with a UE (e.g., UE 102 of FIG. 1), the method 500 may be implemented on a virtual RAN server (e.g., virtualized RAN components 106 of FIG. 1) that is operatively connected to the wireless access point. FIG. 6 illustrates one example of a virtual RAN server 600. The virtual RAN server 600 is an example of the dynamic scheduler discussed above, and may be implemented as a network node. The network node may be located at a site level (e.g., a network level, a geographic level, etc.) of the telecommunications network, and may control scheduling operations for one or more wireless access points (e.g., one or more DUs, one or more RUs, etc.) in the network.

As illustrated, the virtual RAN server 600 comprises a processor 602, a memory 604, and an input/output (I/O) interface 606. The virtual RAN server 600 may be configured with various modules (e.g., various software modules) to implement network management functions, such as traffic management and balancing functions. In one example, the modules may be present in the memory 604 in the form of instructions that, when executed by the processor 602, cause the virtual RAN server 600 to perform any one or more of the operations described herein. In another example, the processor 602 may be configured to load and/or execute instructions from another non-transitory computer-readable medium (e.g., cloud storage or from the memory of another device). In some examples, the following modules may be in the form of xApps and/or rApps (or portions or combinations thereof).

The virtual RAN server 600 may comprise a data receipt module configured to receive a data frame, the data frame being intended for transmission by another network node (e.g., an RU) operating under control of the virtual RAN server 600 or under control of another network node which in turn operates under control of the virtual RAN server 600. The data frame may include payload data, control data, metadata, and the like. In one example, upon receipt, the data frame may be associated with an unordered schedule (e.g., a schedule that has not had any reordering algorithm applied thereto), such as that resembling the power waveform illustrated in FIG. 3A (e.g., data to be transmitted in certain noncontiguous symbols).

The virtual RAN server 600 may comprise a logic module to perform certain calculations and other logical operations. For example, the logic module may be configured to calculate a revised schedule for the data frame, wherein the revised schedule differs from the unordered schedule in at least one of a time domain characteristic or a frequency domain characteristic. This may be performed by performing the calculations described above (e.g., determining a relationship between schedule and power consumption, taking the derivative of the relationship, and calculating the schedule using the derivative.

The virtual RAN server 600 may comprise a scheduling module to generate a revised data frame having the revised schedule. In the example illustrated in FIGS. 3A-B, and as described above, this may include rescheduling the data transmissions into a single contiguous transmission period. The logic module may additionally or alternatively modify the allocation of the data transmissions to frequency resources, such as subcarriers. In the example illustrated in FIGS. 4A-4B, this may include rescheduling the data transmissions into a constant number of frequency resources (or as near to constant as possible). Thus, the virtual RAN server 600 may operate to reduce (e.g., minimize) the overall number of power ON to power OFF transitions and/or the overall number of power OFF to power ON transitions, thus reducing (e.g., minimizing) the power consumption due to rise or fall times of power applied to the PAs of the RU.

The virtual RAN server 600 may comprise a transmission control module to control a transmitter of a wireless access point (or a plurality of wireless access points) that are downstream from the virtual RAN server 600. Thus, the virtual RAN server 600 may cause the transmitter (e.g., the RU) to transmit the reshaped data frame (i.e., to transmit the data frame according to the revised schedule). For example, the dynamic scheduler may pass the reshaped data frame to the transmitter, such that the transmitter transmits the reshaped data frame according to its usual operation.

The I/O 606 may include interface components to permit the communication of data to and from external devices or sources. For example, the I/O 606 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O 606 may additionally or alternatively include communication ports and/or interfaces to permit communication with a user. For example, the I/O 606 may include interfaces for a mouse, a keyboard, a display, a graphical user interface (GUI), buttons, switches, etc. Thus, the I/O 606 may permit a user to initiate the operations described herein and subsequently cause them to be performed on an automated basis and/or may be configured to receive instructions for the automated execution of the operations described herein (e.g., at predetermined intervals).

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of scheduling traffic in a telecommunications network, the method comprising:
receiving a data frame, the data frame including a series of timeslots ordered according to an unordered schedule, wherein the series of timeslots includes at least two noncontiguous groups of data timeslots;
calculating a revised schedule for the data frame, wherein the revised schedule differs from the unordered schedule in at least one of a time domain characteristic or a frequency domain characteristic;
rearranging the timeslots of the data frame according to the revised schedule in at least one of the time domain or the frequency domain, such that the revised schedule includes fewer transmission periods than the unordered schedule; and
causing a transmitter of the telecommunications network to transmit the data frame according to the revised schedule.

2. The method of claim 1, wherein the revised schedule includes a reduced number of contiguous groups of data timeslots in the time domain.

3. The method of claim 2, wherein the revised schedule includes a single contiguous group of data timeslots in the time domain.

4. The method of claim 1, wherein the revised schedule does not include resource blocks at an edge of a spectrum of the data frame, in the frequency domain.

5. The method of claim 1, wherein, according to the revised schedule, a power amplifier associated with the transmitter is in an ON state for fewer timeslots than in the unordered schedule.

6. The method of claim 1, further comprising repeating the operations of receiving the data frame, rearranging the timeslots of the data frame, and causing the transmitter to transmit the data frame a plurality of times for a series of successive data frames.

7. A network node in a telecommunications network, the network node comprising:
at least one processor in communication with a wireless access point; and
a memory storing instructions that, when executed by the at least one processor, cause the network node to:
receive a data frame, the data frame including a series of timeslots ordered according to an unordered schedule, wherein the series of timeslots includes at least two noncontiguous groups of data timeslots,
calculate a revised schedule for the data frame, wherein the revised schedule differs from the unordered schedule in at least one of a time domain characteristic or a frequency domain characteristic,
rearrange the timeslots of the data frame according to the revised schedule in at least one of the time domain or the frequency domain, such that the revised schedule includes fewer transmission periods than the unordered schedule, and
cause a transmitter of the wireless access point to transmit the data frame according to the revised schedule.

8. The network node of claim 7, wherein the revised schedule includes a reduced number of contiguous groups of data timeslots in the time domain.

9. The network node of claim 8, wherein the revised schedule includes a single contiguous group of data timeslots in the time domain.

10. The network node of claim 7, wherein the revised schedule does not include resource blocks at an edge of a spectrum of the data frame, in the frequency domain.

11. The network node of claim 7, wherein, according to the revised schedule, a power amplifier associated with the transmitter is in an ON state for fewer timeslots than in the unordered schedule.

12. The network node of claim 7, wherein the instructions, when executed by the at least one processor, causes the network node to repeat the operations of receiving the data frame, rearranging the timeslots of the data frame, and causing the transmitter to transmit the data frame a plurality of times for a series of successive data frames.

13. The network node of claim 7, wherein the network node is located at a site level of the telecommunications network and is configured to control scheduling operations for a plurality of different wireless access points.

14. A non-transitory computer-readable medium storing instructions that, when executed by at least one processor of a computer in a telecommunications network, cause the compute to perform operations comprising:
receiving a data frame, the data frame including a series of timeslots ordered according to an unordered schedule, wherein the series of timeslots includes at least two noncontiguous groups of data timeslots;
calculating a revised schedule for the data frame, wherein the revised schedule differs from the unordered schedule in at least one of a time domain characteristic or a frequency domain characteristic;
rearranging the timeslots of the data frame according to the revised schedule in at least one of the time domain or the frequency domain, such that the revised schedule includes fewer transmission periods than the unordered schedule; and
causing a transmitter of the telecommunications network to transmit the data frame according to the revised schedule.

15. The non-transitory computer-readable medium of claim 14, wherein the revised schedule includes a reduced number of contiguous groups of data timeslots in the time domain.

16. The non-transitory computer-readable medium of claim 14, wherein the revised schedule includes a single contiguous group of data timeslots in the time domain.

17. The non-transitory computer-readable medium of claim 14, wherein the revised schedule does not include resource blocks at an edge of a spectrum of the data frame, in the frequency domain.

18. The non-transitory computer-readable medium of claim 17, wherein the revised schedule includes an equal or nearly equal number of resource blocks in the frequency domain, for each timeslot.

19. The non-transitory computer-readable medium of claim 14, wherein, according to the revised schedule, a power amplifier associated with the transmitter is in an ON state for fewer timeslots than in the unordered schedule.

20. The non-transitory computer-readable medium of claim 14, the operations further comprising repeating the operations of receiving the data frame, rearranging the symbols/slots of the data frame, and causing the transmitter to transmit the data frame a plurality of times for a series of successive data frames.
